(19) United States
(12) Patent Application Publication
(10) Pub. No.: US 2016/0325978 A1
(43) Pub. Date: Nov. 10, 2016

(54) PORTABLE KEGERATOR COOLER

(71) Applicant: Deep Wood Brew Products, LLC, Holly, MI (US)

(72) Inventor: Kevin Lehman, Holly, MI (US)

(21) Appl. No.: 14/705,204

(22) Filed: May 6, 2015

(51) Int. Cl. B67D 1/04; B67D 1/08; B67D 1/14; B67D 1/00

(52) U.S. Cl. CPC B67D 1/0406; B67D 1/0004; B67D 1/0842; B67D 1/0851; B67D 1/0844; B67D 1/0857; B67D 1/0891; B67D 1/1477

(57) ABSTRACT

A number of variations may include a container that may define a cavity and may include at least one first wall; bottom wall; and a lid; a plurality of liquid containers; a plurality of taps including a plurality of tap handles, a plurality of faucets, a plurality of shanks in communication with the plurality of faucets wherein the plurality of shanks are disposed within the first wall and define a plurality of passages therethrough in communication with the plurality of faucets; a plurality of tubes that each include a first end and a second end wherein the first end of each of the plurality of tubes may be in communication with each of the plurality of shanks; a plurality of couplers in communication with each of the second ends of the plurality of tubes and in communication with each of the plurality of liquid containers.

### TECHNICAL FIELD

The field to which the disclosure generally relates includes beverage dispensing.

### BACKGROUND

Dispensing liquids, such as beer, may include the use of temporary, portable containers such as a growler or fixed, permanent containers such as traditional kegs.

### SUMMARY OF ILLUSTRATIVE VARIATIONS

A number of variations may include a product that may include a container that may define a cavity and may include at least a first wall, a bottom wall, and a lid. The lid may be removably or pivotally attached to another component such as the first wall. The product may further include a plurality of liquid containers; a plurality of taps comprising a plurality of tap handles, a plurality of faucets, a plurality of shanks in fluid communication with the plurality of faucets wherein the plurality of shanks are disposed within the first wall and may define a plurality of passages therethrough in fluid communication with the plurality of faucets. The product may further include a plurality of tubes that may each include a first end and a second end wherein the first end of each of the plurality of tubes may be in fluid communication with each of the plurality of shanks. The product may further include a plurality of couplers in fluid communication with each of the second ends of the plurality of tubes and in fluid communication with each of the plurality of liquid containers.

A number of variations may include a product that may include a container that may define a cavity and may comprise a first wall, a second wall, a third wall, a fourth wall, a bottom wall, and a removable lid. The product may further include a plurality of liquid containers that may each be constructed and arranged to carry about 0.5 gallons to about 2 gallons of liquid. The product may further include a plurality of taps that may include a plurality of tap handles, a plurality of faucets, a plurality of shanks that may be in fluid communication with the plurality of faucets wherein the plurality of shanks may be disposed within the first wall and may define a plurality of passages therethrough which may be in fluid communication with the plurality of faucets. The product may further include a plurality of tubes that may each include a first end and a second end wherein the first end of each of the plurality of tubes may be in fluid communication with each of the plurality of shanks. A product may further include a plurality of couplers and fluid communication with each of the second ends of the plurality of tubes and in fluid communication with each of the plurality of liquid containers; at least one pressurized fluid tank; at least one pressurized fluid regulator and fluid communication with at least one pressurized fluid tank; and a plurality of pressurized fluid tubes in fluid communication with the at least one pressurized fluid regulator and further in fluid communication with each of the plurality of pressurized fluid containers.

A number of variations may include a product that may include a container that may define a cavity and may comprise a first wall, a second wall, a third wall, a fourth wall, a bottom wall, and a removable lid. The product may further include a plurality of liquid containers that may each be constructed and arranged to contain about 0.5 gallons to about 2 gallons of liquid. The product may further include a plurality of taps that may include a plurality of tap handles, a plurality of faucets, a plurality of shanks in fluid communication with the plurality of faucets wherein the plurality of shanks may be disposed within the first wall and may define a plurality of passages therethrough in fluid communication with the plurality of faucets wherein the plurality of faucets each may further include a faucet inlet, a faucet outlet, and a faucet valve disposed between the faucet inlet and the faucet outlet constructed and arranged to be in fluid communication with each of the plurality of tap handles. The product may further include a plurality of tubes that may each include a first end and a second end wherein the first end of each of the plurality of tubes is in fluid communication with each of the plurality of shanks; a plurality of couplers in fluid communication with each of the second ends of the plurality of tubes and in fluid communication with each of the plurality of liquid containers. A product may further include a carbonation system that may include at least one of a pressurized carbon dioxide or nitrogen tank; at least one pressurized fluid regulator in fluid communication with the at least one of a pressurized carbon dioxide or nitrogen tank; and a plurality of pressurized fluid tubes in fluid communication with the at least one pressurized fluid regulator and further in fluid communication with each of the plurality of liquid containers. The carbonation system may be constructed and arranged to regulate and facilitate the flow of fluid from the at least one of a pressurized carbon dioxide or nitrogen tank; to the plurality of liquid containers via the at least one pressurized fluid regulator and plurality of pressurized fluid tubes.

Other illustrative variations within the scope of the invention will become apparent from the detailed description provided hereinafter. It should be understood that the detailed description and enumerated variations, while disclosing optional variations, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 depicts one variation of a portable kegerator cooler; and

FIG. 2 depicts one variation of a portable kegerator cooler.

### DETAILED DESCRIPTION OF ILLUSTRATIVE VARIATIONS

The following description of the variations is merely illustrative in nature and is in no way intended to limit the scope of the invention, its application, or uses. The following description of variants is only illustrative of components, elements, acts, products, and methods considered to be within the scope of the invention and are not in any way intended to limit such scope by what is specifically disclosed or not expressly set forth. The components, elements, acts, products, and methods as described herein may be combined and rearranged other than as expressly described herein and still are considered to be within the scope of the invention.

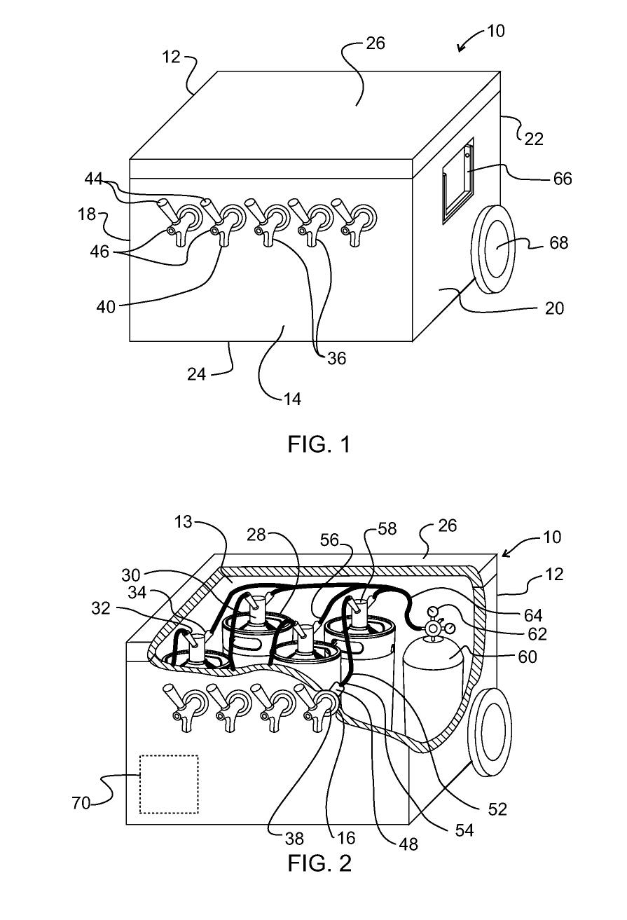

Referring to FIGS. 1 and 2; a beverage dispensing system 10 may include a container 12 that may define a cavity 13. The container 12 may include a first wall 14 defining a plurality of through holes 16, a second wall 18, a third wall 20, a fourth wall 22, a bottom wall 24, and a removable lid 26. The first wall 14, second wall 18, third wall 20, fourth wall 22, bottom wall 24, and removable lid 26 may include an insulating material as well as a durable exterior layer.

The container 12 may further include at least one wheel 68 and at least one handle 66 to facilitate transportation of the container 12. The handle 66 may be hingedly fixed to the container 12 and may be extendable.

A plurality of taps 36 extend from the first wall 14 and may be in fluid communication with a plurality of shanks 48 that define a plurality of passages (not shown) therethrough that may be in fluid communication with a plurality of tubes 52 which may be in fluid communication with a plurality of couplers 58 which may be sanke type couplers. The plurality of taps 36 may include a plurality of faucets 46 which may include each a faucet inlet 38, a faucet outlet 40, and a faucet valve (not shown) which may be constructed and arranged to regulate the flow of fluid through the faucet. A plurality of tap handles 44 may be affixed to the plurality of faucets 46 and may be constructed and arranged to control the movement of the faucet valve to regulate the flow of fluid through the faucet.

The couplers 58 may include a fluid outlet 32 and a fluid inlet 34. The couplers 58 may be connected to a plurality of pressurized liquid containers 28 having a plurality of connections 30. The plurality of pressurized liquid containers 28 maybe be stainless steel and may be constructed and arranged to hold about 0.5 gallons to about 2.0 gallons of liquid at pressures up to about 130 PSI.

A plurality of pressurized fluid tubes 64 may include a first end 54 that may extend from the fluid inlet 34 and a second end 56 that may be in fluid communication with at least one pressurized fluid regulator 62 which may be in fluid communication with at least one pressurized fluid tank 60. The pressurized fluid tank 60 may be at least one of a pressurized carbon dioxide or nitrogen tank.

A refrigeration unit 70 may be disposed within the cavity 13, or within one of the first wall 14, second wall 18, third wall 20, fourth wall 22, or the bottom wall 24 and may be constructed and arranged to refrigerate the cavity 13.

In practice and in use, the at least one pressurized fluid tank, the at least one pressurized fluid regulator, and the plurality of pressurized tubes may make up a carbonation system constructed and arranged to carbonate fluid contents of the plurality of pressurized liquid containers. The plurality of taps may be constructed and arranged to flow liquid from the plurality of pressurized liquid containers wherein each individual tap corresponds to each individual plurality of pressurized liquid container

According to variation 1, a number of variations may include a product that may include a container that may define a cavity and may include at least a first wall, a bottom wall, and a lid. The product may further include a plurality of liquid containers; a plurality of taps comprising a plurality of tap handles, a plurality of faucets, a plurality of shanks and fluid communication with the plurality of faucets wherein the plurality of shanks are disposed within the first wall and may define a plurality of passages therethrough in fluid communication with the plurality of faucets. The product may further include a plurality of tubes that may each include a first end and a second end wherein the first end of each of the plurality of tubes may be in fluid communication with each of the plurality of shanks. The product may further include a plurality of couplers in fluid communication with each of the second ends of the plurality of tubes and in fluid communication with each of the plurality of liquid containers.

Variation 2 may include a product as set forth in variation 1 wherein the at least one first wall, the bottom wall, and the lid may include an insulating material.

Variation 3 may include a product as set forth in variations 1 or 2 wherein the liquid containers may each include a valve defining a fluid inlet and a fluid outlet.

Variation 4 may include a product as set forth in any of variations 1 through 3 wherein the liquid containers may each be constructed and arranged to contain about 0.5 gallons to about 2 gallons of liquid.

Variation 5 may include a product as set forth in any of variations 1 through 4 wherein the liquid containers may each be one gallon beer containers.

Variation 6 may include a product as set forth in any of variations 1 through 5 wherein the plurality of faucets may each further include a faucet inlet, a faucet outlet, and a faucet valve disposed between the faucet inlet and the faucet outlet and may be constructed and arranged to be in communication with each of the plurality of tap handles.

Variation 7 may include a product as set forth in any of variations 1 through 6 and may further include at least one pressurized fluid tank; at least one pressurized fluid regulator that may be in fluid communication with the at least one pressurized fluid tank; and a plurality of pressurized fluid tubes that may be in fluid communication with the at least one pressurized fluid regulator and may further be in fluid communication with each of the plurality of liquid containers.

Variation 8 may include a product as set forth in variation 7 wherein at least one pressurized fluid tank may be at least one of a pressurized carbon dioxide or nitrogen tank.

Variation 9 may include a product as set forth in any of variations 1 through 8 and may further include at least one wheel disposed on the at least one first wall or bottom wall which may be constructed and arranged to facilitate transportation of the containers and at least one handle that may be disposed on the at least one first wall or bottom wall and may be constructed and arranged to facilitate transportation of the container.

Variation 10 may include a product as set forth in any of variations 1 through 9 wherein the plurality of liquid containers may include about two liquid containers to about five liquid containers.

According to variation 11, a number of variations may include a product that may include a container that may define a cavity and may comprise a first wall, a second wall, a third wall, a fourth wall, a bottom wall, and a removable lid. The product may further include a plurality of liquid containers that may each be constructed and arranged to carry about 0.5 gallons to about 2 gallons of liquid. The product may further include a plurality of taps that may include a plurality of tap handles, a plurality of faucets, a plurality of shanks that may be in fluid communication with the plurality of faucets wherein the plurality of shanks may be disposed within the first wall and may define a plurality of passages therethrough which may be in fluid communication with the plurality of faucets. The product may further include a plurality of tubes that may each include a first end and a second end wherein the first end of each of the plurality of tubes may be in fluid communication with each of the plurality of shanks. A product may further include a plurality of couplers and fluid communication with each of the second ends of the plurality of tubes and in fluid communication with each of the plurality of liquid containers; at least one pressurized fluid tank; at least one pressurized fluid regulator and fluid communication with at least one pressurized fluid tank; and a plurality of pressurized fluid tubes in fluid communication with the at least one pressurized fluid regulator and further in fluid communication with each of the plurality of pressurized fluid containers.

Variation 12 may include a product as set forth in variation 11 wherein the first wall, the second wall, the third wall, the fourth wall, the bottom wall, and the removable lid may include an insulating material.

Variation 13 may include a product as set forth in any of variations 11 through 12 wherein the liquid containers may each include a valve that may define a fluid inlet and a fluid outlet.

Variation 14 may include a product as set forth in any of variations 11 through 13 wherein the liquid container may be 1 gallon beer containers.

Variation 15 may include a product as set forth in any of variations 11 through 14 wherein the plurality of faucets may each further include a faucet inlet, a faucet outlet, and a faucet valve that may be disposed between the faucet inlet and the faucet outlet that may be constructed and arranged to be in communication with each of plurality of tap handles.

Variation 16 may include a product as set forth in any of variations 11 through 15 wherein the at least one pressurized fluid tank is at least one of a pressurized carbon dioxide or nitrogen tank.

Variation 17 may include a product as set forth in any of variations 11 through 16 and may further include at least one wheel disposed on the first wall, second wall, third wall, fourth wall, or bottom wall and may be constructed and arranged to facilitate transportation of the container. The product may further include at least one handle disposed on the first wall, the second wall, the third wall, the fourth wall, or bottom wall and may be constructed and arranged to facilitate transportation of the container.

According to variation 18, a number of variations may include a product that may include a container that may define a cavity and may comprise a first wall, a second wall, a third wall, a fourth wall, a bottom wall, and a removable lid. The product may further include a plurality of liquid containers that may each be constructed and arranged to contain about 0.5 gallons to about 2 gallons of liquid. The product may further include a plurality of taps that may include a plurality of tap handles, a plurality of faucets, a plurality of shanks in fluid communication with the plurality of faucets wherein the plurality of shanks may be disposed within the first wall and may define a plurality of passages therethrough in fluid communication with the plurality of faucets wherein the plurality of faucets each may further include a faucet inlet, a faucet outlet, and a faucet valve disposed between the faucet inlet and the faucet outlet constructed and arranged to be in fluid communication with each of the plurality of tap handles. The product may further include a plurality of tubes that may each include a first end and a second end wherein the first end of each of the plurality of tubes is in fluid communication with each of the plurality of shanks; a plurality of couplers in fluid communication with each of the second ends of the plurality of tubes and in fluid communication with each of the plurality of liquid containers. A product may further include a carbonation system that may include at least one pressurized carbon dioxide tank; at least one pressurized fluid regulator in fluid communication with the at least one pressurized carbon dioxide tank; and a plurality of pressurized fluid tubes in fluid communication with the at least one pressurized fluid regulator and further in fluid communication with each of the plurality of liquid containers. The carbonation system may be constructed and arranged to regulate and facilitate the flow of carbon dioxide from the at least one pressurized carbon dioxide tank to the plurality of liquid containers via the at least one pressurized fluid regulator and plurality of pressurized fluid tubes.

Variation 19 may include a product as set forth in variation 18 and may further include a refrigeration unit constructed and arranged to facilitate cooling of the cavity.

Variation 20 may include a product as set forth in any of variations 18 through 19 and may further include at least one wheel disposed on the first wall, second wall, third wall, fourth wall, or bottom wall and may be constructed and arranged to facilitate transportation of the container. The product may further include at least one handle that may be disposed on the first wall, second wall, third wall, fourth wall, or bottom wall and may be constructed and arranged to facilitate transportation of the container.

The above description of variations of the invention is merely demonstrative in nature and, thus, variations thereof are not to be regarded as a departure from the spirit and scope of the inventions disclosed within this document.

What is claimed is:

1. A product comprising:
a container defining a cavity and comprising at least one first wall, a bottom wall, and a lid;
a plurality of liquid containers;
a plurality of taps comprising a plurality of tap handles, a plurality of faucets, a plurality of shanks in fluid communication with the plurality of faucets wherein the plurality of shanks are disposed within the first wall and define a plurality of passages therethrough in fluid communication with the plurality of faucets;
a plurality of tubes each comprising a first end and a second end wherein the first end of each of the plurality of tubes is in fluid communication with each of the plurality of shanks; and
a plurality of couplers in fluid communication with each of the second ends of the plurality of tubes and in fluid communication with each of the plurality of liquid containers.

2. A product according to claim 1, wherein the at least one first wall, bottom wall, and lid comprise an insulating material.

3. A product as set forth in claim 1, wherein the liquid containers each comprise a valve defining a fluid inlet and a fluid outlet.

4. A product as set forth in claim 1, wherein the liquid containers are each constructed and arranged to contain about 0.5 gallons to about 2 gallons of liquid.

5. A product as set forth in claim 4, wherein the liquid containers are 1 gallon beer containers.

6. A product as set forth in claim 1, wherein the plurality of faucets each further comprise a faucet inlet, a faucet outlet, and a faucet valve disposed between the faucet inlet and the faucet outlet constructed and arranged to be in communication with each of the plurality of tap handles.

7. A product as set forth in claim 1, further comprising:
at least one pressurized fluid tank;
at least one pressurized fluid regulator in fluid communication with the at least one pressurized fluid tank; and
a plurality of pressurized fluid tubes in fluid communication with the at least one pressurized fluid regulator and further in fluid communication with each of the plurality of liquid containers.

8. A product as set forth in claim 7, wherein the at least one pressurized fluid tank is at least one of a carbon dioxide or nitrogen tank.

9. A product as set forth in claim 1, further comprising:
at least one wheel disposed on the at least one first wall or bottom wall and being constructed and arranged to facilitate transportation of the container; and
at least one handle disposed on the at least one first wall or bottom wall and being constructed and arranged to facilitate transportation of the container.

10. A product as set forth in claim 1, wherein the plurality of liquid containers comprises about 2 liquid containers to about 5 liquid containers.

11. A product comprising:
a container defining a cavity and comprising a first wall, a second wall, a third wall, a fourth wall, a bottom wall, and a removable lid;
a plurality of liquid containers each constructed and arranged to contain about 0.5 gallons to about 2 gallons of liquid;
a plurality of taps comprising a plurality of tap handles, a plurality of faucets, a plurality of shanks in fluid communication with the plurality of faucets wherein the plurality of shanks are disposed within the first wall and define a plurality of passages therethrough in fluid communication with the plurality of faucets;
a plurality of tubes each comprising a first end and a second end wherein the first end of each of the plurality of tubes is in fluid communication with each of the plurality of shanks;
a plurality of couplers in fluid communication with each of the second ends of the plurality of tubes and in fluid communication with each of the plurality of liquid containers;
at least one pressurized fluid tank;
at least one pressurized fluid regulator in fluid communication with the at least one pressurized fluid tank; and
a plurality of pressurized fluid tubes in fluid communication with the at least one pressurized fluid regulator and further in fluid communication with each of the plurality of liquid containers.

12. A product according to claim 11, wherein the first wall, second wall, third wall, fourth wall, bottom wall, and removable lid comprise an insulating material.

13. A product as set forth in claim 11, wherein the liquid containers each comprise a valve defining a fluid inlet and a fluid outlet.

14. A product as set forth in claim 11, wherein the liquid containers are 1 gallon beer containers.

15. A product as set forth in claim 11, wherein the plurality of faucets each further comprise a faucet inlet, a faucet outlet, and a faucet valve disposed between the faucet inlet and the faucet outlet constructed and arranged to be in communication with each of the plurality of tap handles.

16. A product as set forth in claim 11, wherein the at least one pressurized fluid tank is at least one of a carbon dioxide or nitrogen tank.

17. A product as set forth in claim 11, further comprising:
at least one wheel disposed on the first wall, second wall, third wall, fourth wall, or bottom wall and being constructed and arranged to facilitate transportation of the container; and
at least one handle disposed on the first wall, second wall, third wall, fourth wall, or bottom wall and being constructed and arranged to facilitate transportation of the container.

18. A product comprising:
a container defining a cavity and comprising a first wall, a second wall, a third wall, a fourth wall, a bottom wall, and a removable lid;
a plurality of liquid containers each constructed and arranged to contain about 0.5 gallons to about 2 gallons of liquid;
a plurality of taps comprising a plurality of tap handles, a plurality of faucets, a plurality of shanks in fluid communication with the plurality of faucets wherein the plurality of shanks are disposed within the first wall and define a plurality of passages therethrough in fluid communication with the plurality of faucets wherein the plurality of faucets each further comprise a faucet inlet, a faucet outlet, and a faucet valve disposed between the faucet inlet and the faucet outlet constructed and arranged to be in communication with each of the plurality of tap handles;
a plurality of tubes each comprising a first end and a second end wherein the first end of each of the plurality of tubes is in fluid communication with each of the plurality of shanks;
a plurality of couplers in fluid communication with each of the second ends of the plurality of tubes and in fluid communication with each of the plurality of liquid containers;
a carbonation system comprising:
at least one of a carbon dioxide or nitrogen tank;
at least one pressurized fluid regulator in fluid communication with the at least one of a carbon dioxide or nitrogen tank; and
a plurality of pressurized fluid tubes in fluid communication with the at least one pressurized fluid regulator and further in fluid communication with each of the plurality of liquid containers;
wherein the carbonation system is constructed and arranged to regulate and facilitate the flow of fluid from the at least one of a carbon dioxide or nitrogen tank to the plurality of liquid containers via the at least one pressurized fluid regulator and plurality of pressurized fluid tubes.

19. A product as set forth in claim 18, further comprising:
a refrigeration unit constructed and arranged to facilitate cooling of the cavity.

20. A product as set forth in claim 18, further comprising:
at least one wheel disposed on the first wall, second wall, third wall, fourth wall, or bottom wall and being constructed and arranged to facilitate transportation of the container; and
at least one handle disposed on the first wall, second wall, third wall, fourth wall, or bottom wall and being constructed and arranged to facilitate transportation of the container.
